(19) United States
(12) Patent Application Publication
(10) Pub. No.: US 2005/0131266 A1
(43) Pub. Date: Jun. 16, 2005

(54) Carbonaceous waste treatment system and method

(75) Inventors: Brent G. Carman, Fulton, KY (US); Harold Speidel, Decatur, AL (US)

Correspondence Address: DORITY & MANNING, P.A., POST OFFICE BOX 1449, GREENVILLE, SC, 29602-1449, US

(73) Assignee: Clemson University

(21) Appl. No.: 10/962,056

(22) Filed: Oct. 8, 2004

Related U.S. Application Data
(60) Provisional application No. 60/509,692, filed on Oct. 8, 2003.

(51) Int. Cl. A62D 3/00; B01J 19/08

(52) U.S. Cl. 588/320; 422/186.07

(57) ABSTRACT

Disclosed is a method and system for treating carbonaceous waste materials. The method includes contacting the waste with ozone in order to promote oxidation of the organic materials in the waste. The process can be carried out in a large waste storage facility such as a lagoon, a pond, or an aboveground storage facility. In one embodiment, the process can be utilized for treatment of waste in remote access locations, such as on shipboard or other remote or isolated locations. The method can be used in an on-going batch or continuous treatment process or can be used for remediation and reclamation of storage facilities. The invention is also directed to a self-contained unit capable of treating small amount of waste. The treatment unit can be used to treat waste in isolated areas such as, for example, medical waste generated in medical or research facilities.

### CROSS REFERENCE TO RELATED APPLICATION

This application claims benefit to U.S. Provisional Application Ser. No. 60/509,692 filed Oct. 8, 2003.

### BACKGROUND

One major dilemma plaguing facilities that produce carbonaceous waste is the ability to efficiently neutralize and dispose of the waste. For example, agricultural facilities housing large numbers of animals produce wastewater which can include some combination of manure, urine, and/or silage pit drainage, waste feed, wash down waters, contaminated precipitation, and bulk tank wastewater. Similarly, people in remote and clinical circumstances produce carbonaceous waste. For instance, medical facilities can produce a great deal of carbonaceous waste that can pose potential biohazard. Left untreated, carbonaceous waste can pose a significant health and environmental hazard. Carbonaceous waste can also create a public nuisance because of its odor, and improper disposal of waste is associated with significant problems such as water and ground contamination.

A need currently exists for improved systems and processes for treating carbonaceous waste. In addition, a need exists for methods for remediation and reclamation of storage facilities that have been rendered useless due to the over-accumulation of solid waste. A need also exists for systems and processes that can reduce at least one of biochemical oxygen demand (BOD), chemical oxygen demand (COD), total bacterial count, and/or the total coliform count present in carbonaceous waste.

### SUMMARY OF THE INVENTION

In one embodiment, the present invention is directed to a process for treating medical waste. For instance, the process can include collecting medical waste in a treatment chamber and contacting the medical waste with a gas comprising ozone. The ozone can be fed to the chamber in an amount sufficient to oxidize at least a portion of any organic matter contained in the medical waste and decontaminate the medical waste. Thus, the medical waste can be rendered safe for disposal in, for example, a municipal waste facility.

In one embodiment, the medical waste to be treated can be aqueous waste. For example, in one embodiment, the waste can be an aqueous slurry or sludge.

The decontaminated medical waste can have, in one embodiment, a measure of total suspended solids of less than about 30 mg/L. In one embodiment the decontaminated medical waste can have a biochemical oxygen demand of less than about 30 mg/L and/or a fecal coliform count of less than about 200 colonies/100 mL.

In one embodiment, the medical waste can include solid materials. Optionally, at least some of the solid materials in the waste can be ground or chopped during the process. For example, the medical waste can include solid carbonaceous materials that can include solid carbonaceous polymeric materials. In one particular embodiment, solid materials in the medical waste can include biodegradable polymeric materials. Carbonaceous solid materials can be partially degraded during the waste treatment process according to one embodiment of the disclosed method.

Following the disclosed treatment method, the decontaminated waste can be “green bag” waste rather than “red bag” waste, when considering medical waste. For example, following the disclosed process, the decontaminated waste can be safely and permanently disposed of, for instance in a municipal waste disposal facility such as a landfill or a sewage treatment facility.

The method can also include a variety of pre- and post-treatment processes. For instance, at least one of the following methods can be included in the process: any remaining solids can be separated from the decontaminated waste, chemical flocculants can be introduced to the waste, hydrogen peroxide can be introduced to the waste, the waste can be filtered prior to treatment, or the waste and/or the off-gas can be contacted with ultraviolet light, for example to destroy any remaining ozone in the gas following the process.

In one embodiment, the invention is directed to a waste treatment unit. For example, the waste treatment unit can be a self-contained waste treatment unit including a contact chamber, a waste inlet for depositing waste into the contact chamber, an ozone system for providing a gas comprising ozone to the contact chamber, and an outlet for removing treated waste from the waste treatment unit. The unit can be designed such that the ozone can contact waste deposited into the contact chamber in an amount sufficient to oxidize at least a portion of any organic matter contained in the waste.

The unit of the invention can include other features as well. For example, in one embodiment, the unit can include a device for chopping or grinding the waste materials. In one embodiment, the unit can include a waste storage chamber for storing waste prior to depositing the waste in the contact chamber. Optionally, the unit can include a solids separating device for separating solids from the treated waste stream. Another optional component of the disclosed device is an ultraviolet light.

The ozone system can provide an ozone-containing gas according to any method as is generally known in the art. For example, in one embodiment, the ozone system can include an ozone-generating device.

The self-contained waste treatment unit of the invention can be portable, if desired, and can be sized depending upon the desired use and/or location of the device. For example, in one embodiment, the self-contained waste treatment unit can occupy less than about 40 cubic feet of space. In another embodiment, the self-contained waste treatment unit can occupy less than about 30 cubic feet of space.

In one particular embodiment, the waste treatment unit can be utilized for decontaminating medical waste.

### BRIEF DESCRIPTION OF THE FIGURES

A full and enabling disclosure of the present invention, including the best mode thereof, to one of ordinary skill in the art, is set forth more particularly in the remainder of the specification, including reference to the accompanying figures, in which:

FIG. 1 is a schematic diagram of one embodiment of the process of the present invention;

FIG. 2 is one embodiment of an ozone system according to the present invention;

FIG. 3 is a schematic diagram of one embodiment for treating a waste storage facility according to the present invention;

FIG. 4 is a schematic diagram of another embodiment for treating a waste storage facility according to the present invention;

FIG. 5 is a schematic diagram of one embodiment of the invention that can be used in one embodiment for reclamation of a waste storage facility which has an over-accumulation of solid waste;

FIG. 6 is a diagram representing another embodiment of the present invention;

FIG. 7 is a schematic diagram of a self-contained waste storage and treatment unit according to one embodiment of the present invention;

FIGS. 8A and 8B graphically illustrate the results of ozone contact on an aqueous swine waste;

FIGS. 9A-9D graphically illustrate the results of ozone contact with a large swine waste lagoon over the course of several days; and

FIGS. 10A and 10B graphically illustrate the results of utilizing the disclosed methods on an aqueous waste when combined with a pre-filtration step.

Repeat use of reference characters in the present specification and drawings is intended to represent same or analogous features or elements of the present invention.

### DETAILED DESCRIPTION OF THE INVENTION

Reference will now be made in detail to various embodiments of the invention, one or more examples of which are set forth below. Each embodiment is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment, can be used in another embodiment to yield a still further embodiment. Thus, it is intended that the present invention cover such modifications and variations as come within the scope of the appended claims and their equivalents.

In one embodiment, the present invention is directed to a process for treating carbonaceous waste. In another embodiment, the invention is directed to waste treatment systems and devices that can be utilized for treatment of carbonaceous waste according to the disclosed processes. For purposes of this disclosure, carbonaceous waste is herein defined as material that, while it can include other types of inorganic materials, also includes carbon-based, organic materials.

In one embodiment, the system and process of the present invention are directed toward treating carbonaceous waste such as can be held either temporarily or permanently in a storage facility. In another embodiment, the invention is directed to a continuous process for treating waste in-line. In general, the treatment process includes treatment of carbon-containing waste with ozone in an amount sufficient to oxidize at least some of any organic matter contained in the waste.

Treatment of carbonaceous waste according to the present invention can result in a significant reduction in the biochemical oxygen demand (BOD), chemical oxygen demand (COD), total bacteria count, and/or coliform bacteria count of the waste or of water carrying the waste. Ozone treatment of the waste can also bleach the waste and destroy compounds in the waste responsible for offensive odors. In addition, the processes of the present invention can decrease the turbidity of an aqueous waste and improve its color as well as reduce suspended and volatile solids in wastewater. Oxidation of the waste material can also destroy organisms in the waste, including potentially infectious or otherwise pathogenic organisms and materials such as viruses, bacteria, toxins, fungi, and dormant forms of bacteria and fungi including biological material that is wet, dry, or sporulated.

In one embodiment, the present invention is directed to carbonaceous waste produced or collected at agricultural facilities, and in particular, agricultural facilities which house livestock. Agricultural facilities as well as other types of commercial facilities often use contained areas to house livestock for at least a portion of the animal's life. For example, farming operations, poultry houses and livestock production facilities can segregate some, if not all, of the animals in a barn or other enclosed structure. Likewise, other types of facilities which have animal housing needs such as dog kennels, medical facilities, research laboratories, and the like can breed and/or house animals in an enclosed structure. The housing of livestock often presents a problem to the animal caretaker, however, in that excrement and other waste products such as spilled feed must be collected and properly discarded. One disposal solution is to flush the floor of the animal containment area with running water so as to produce a carbonaceous waste slurry, sludge, or solution. The carbonaceous waste can be subsequently flushed via a drain into a storage facility. Alternately, carbonaceous waste can be collected manually and disposed of in a storage facility. Generally, the storage facilities can be either aboveground facilities, such as aboveground tanks common to or required in some geographical areas, or in-ground facilities, such as in-ground ponds or lagoons (often clay-lined) common in other geographical areas.

While certain waste sent to a storage facility can be removed from the storage facility and spread on arable land under certain circumstances, this is possible only under limited atmospheric conditions and in limited amounts. Thus, waste tends to accumulate and remain in storage facilities when waste is collected over a period of time. Not only can this give rise to requirements for exceptionally large waste storage capabilities, but also, due to the length of time spent in stagnant storage, solids have the opportunity to separate from wastewater and collect on the bottom of the storage facilities. Over time, as solids accumulate and water evaporates, the accumulated solids can raise the bottom of the storage facility, decreasing the amount of waste that can be charged to the facility and, in some cases, rendering the storage facility no longer functional.

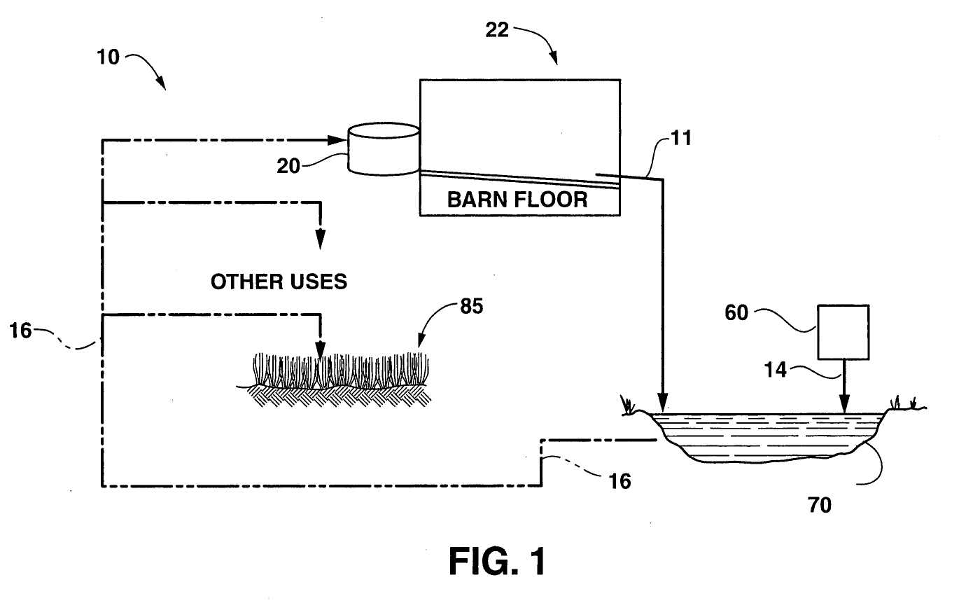

Referring to FIG. 1, one system is illustrated for a carbonaceous waste treatment process such as can be utilized at, for example, an animal storage facility. System 10 generally comprises a flush tank 20, a barn or other containment area 22 where the carbonaceous waste can be produced, a waste storage facility 70, and an ozone system 60. System 10 can further include conduit 11, connecting the containment area 22 to storage facility 70; and discharge line 16, which can be utilized to remove treated material from storage facility 70. In certain embodiments, treated material can be removed from storage facility 70 for other specific purposes. For example, discharge line 16 can connect storage facility 70 back to flush tank 20, to plant system 85, and/or various other possible uses, such as other gray water or fresh water uses.

According to the present invention, flush tank 20 can be configured as a tank, a drum, a chamber, a cylinder, a fluid hose, a fluid pipe, or in any other shape sufficient to deliver a suitable amount of flush water to the containment area 22 in order to move carbonaceous waste collected at the containment area 22 to storage facility 70. The tank can be made of various materials in accordance with the invention, such as steel, concrete, aluminum, or any other material suitable for holding fluid. The size of the tank can range from about 1 gallon to about 1,000,000 gallons, depending on the size of the operation.

In one preferred embodiment, flush tank 20 can further comprise a mechanism for rapidly releasing flush water. According to the present invention, the mechanism can include a pump with power sufficient to pump water from tank 20 through conduit 11 to storage facility 70. Alternately, flush water can be discharged gravitationally from flush tank 20.

In accordance with the present invention, conduit 11, connecting containment area 22 to storage facility 70, can comprise a floor, a pipe, a tube, a channel or any other device suitable for safely transporting a fluid solution from a source to a receptacle. Fluid can be driven through conduit 11 as a result of force generated by a pump or, alternatively, the fluid can be conducted through conduit 11 by gravity. Fluid flowing through conduit 11 can flush carbonaceous waste from the containment area 22 to storage facility 70.

According to the present invention, carbonaceous waste can be deposited into storage facility 70. As described above, the waste can be deposited into storage facility 70 as a waste solution, slurry, or sludge including waste flushed from the containment area 22 mixed with flush water from flush tank 20. In an alternative embodiment, carbonaceous waste can be collected from the containment area 22 by some other process and deposited into storage facility 70. For instance, essentially dry solid waste or an aqueous waste can be collected at containment area 22 and moved, for example, via a truck, wheelbarrow, or the like, to be deposited in storage facility 70, where it can be mixed with water to form a waste solution, sludge, or slurry for treatment.

In one embodiment, storage facility 70 can be configured as an aboveground storage facility such as an aboveground concrete or metal waste storage tank or some other type of holding tank. In an alternative embodiment, storage facility 70 can be an in-ground facility, such as an in-ground wastewater pond or lagoon.

Storage facility 70 can be associated with an ozone system 60 that can provide ozone for contact with the waste. In one embodiment, the waste can be ground prior to or following deposition in storage facility 70. For instance conduit 11 can include an inline grinder for grinding the waste. Grinding of the waste can increase the surface area of the organic material accessible to ozone treatment and decrease treatment time, though the inclusion of a grinder is not a requirement of the system.

In one embodiment, ozone system 60 can include an ozone-generating device such as an ozonator. An ozonator can generate ozone by, for example, applying electricity to air or oxygen as is generally known in the art and produce ozone-enriched air. While certain embodiments contemplate an ozone system 60 comprising an ozone generator, other methods that can provide ozone for contact with the carbonaceous waste are also contemplated by the present invention. For example, in another embodiment, ozone system 60 can include a refillable or replaceable tank of ozone or ozone-containing gas that can be provided from an external source.

Ozone system 60 can be sized so as to provide any desired amount of ozone to the carbonaceous waste. For instance, in an embodiment wherein a relatively small amount of waste is to be treated or where the treatment time can be relatively long, ozone system 60 can be sized to contact the waste with a small amount of ozone, such as, for example less than about 10 pounds of ozone per day. Alternatively, in those embodiments where quicker treatment times are preferred, or when a large volume of waste is to be treated, such as, for example, when relatively fast remediation of a large storage facility is contemplated, the ozone system can be larger and can contact the waste with, for instance, up to about 500 pounds of ozone per day. In one preferred embodiment, the ozone system 60 can be adjusted so as to deliver more or less ozone to the storage facility 70, depending on the requirements of the system. For instance, when waste is introduced to the system, or when quick treatment of waste held in the storage facility 70 is desired, the ozone output of the ozone system 60 can increase. Similarly, as the organic constituents in the waste are oxidized, or when slower treatment is suitable, the ozone system output can decrease. For example, if the system is very small, or when no waste is being introduced into a storage facility, ozone can be introduced merely to maintain the cleanliness of the water already held in the storage facility. In such an embodiment, ozone delivery requirements can be very low, such as about one pound of ozone per day, for example.

Optionally, ozone system 60 can include additional components which can, for instance, increase the amount of ozone produced, increase or decrease the purity of the ozone-containing gas produced, or improve the efficiency of the ozone production process.

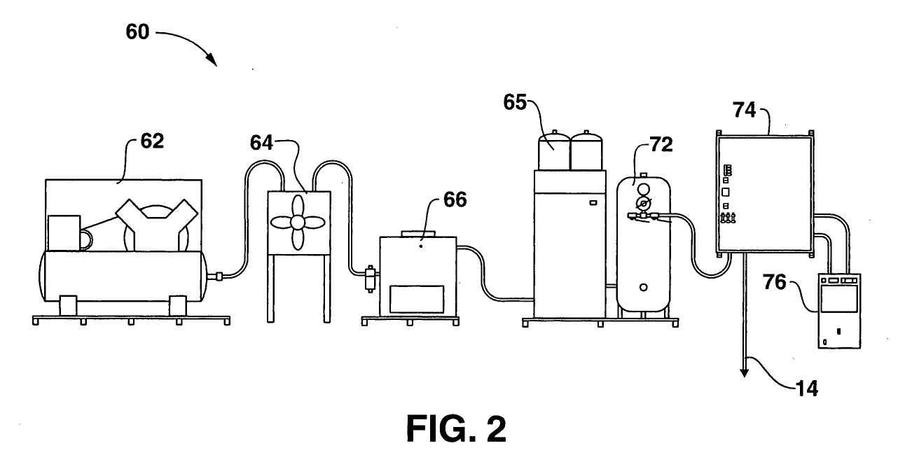

FIG. 2 illustrates one embodiment of ozone system 60 that includes an air compressor 62 to deliver pressurized air to the system, an air-cooled after-cooler 64, a refrigerated air dryer 66, an oxygen generator 68 with a storage tank 72, an ozone generator 74, and a cooling water chiller 76.

Ozone generator 74 can include a source of electricity to produce ozone from air or oxygen. In one preferred embodiment, the electricity source for the ozone generator 74 can include a photoelectric array. However, other sources of electricity useful for producing ozone from air or oxygen are equally contemplated by the present invention. Ozone system 60 can also include a conduit 14 to deliver the ozone from ozone system 60 to storage tank 70.

It should be understood that the particular components of ozone system 60 as illustrated in FIG. 2 are not required by the present invention, however. In various embodiments, only some of the components can be included in ozone system 60. In another embodiment, the ozone system of the invention can include completely different components. The only requirement of the ozone system of the invention is that it is capable of delivering ozone or an ozone-containing gas.

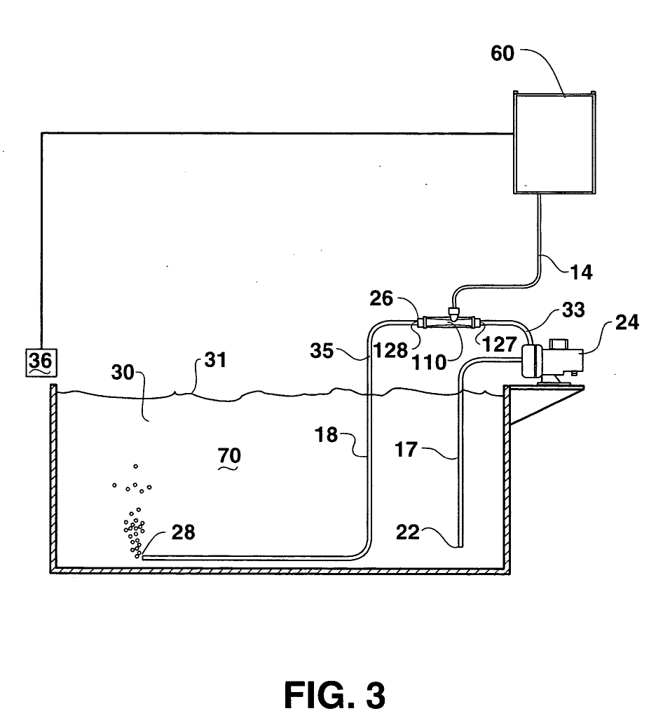

One embodiment of a process for treating waste held in a waste storage facility according to the present invention is illustrated in FIG. 3. In this particular embodiment, the system can include waste intake 22 through which waste can be carried via intake conduit 17 utilizing, for example, pump 24. Optionally, waste intake 22 can include a screen or filter to prevent rocks, twigs, or other large solids that could plug the system from entering waste intake 22. Pump 24 can move a stream 33 of waste 30 in solution, sludge, or slurry form from storage facility 70 through conduit 17 and to connector 26. At connector 26, the waste stream 33 can be contacted with ozone or ozone-containing gas to form ozonated waste stream 35 in which oxidation of the organic components in the waste by the ozone can begin.

As embodied by the present invention, connector 26 can comprise a tube, pipe, injector, nozzle, channel or other device suitable to allow ozone to contact the waste in an amount sufficient to oxidize at least a portion of any organic material contained in the storage facility 70. In one embodiment, ozone system 60 can be permanently connected to waste intake 22 at connector 26, however, a temporary connection between ozone system 60 and waste intake 22 via connector 26 is also contemplated by the present invention. A permanent connection being one which is established with the intent of remaining over a long period of time, and a temporary connection being that which is intended to be maintained for a short period of time, such as, for example, a month or less.

In one embodiment of the present system, and as illustrated in FIG. 3, connector 26 can include an inlet 127 separated from an outlet 128 by a venturi 110. Venturi 110 can be in communication with ozone system 60 via conduit 14. A venturi is a constriction that is placed in a pipe or tube that causes a drop in pressure as fluid flows through the venturi. The venturi 110 can include a straight section or a throat positioned in between two tapered sections. When used in the process of the present invention, the venturi can draw the ozone in conduit 14 into the waste stream 33 and can encourage mixing of the waste stream with the ozone.

Using a venturi in the system of the present invention offers various advantages. For instance, the venturi can allow the ozone to rapidly combine with the aqueous stream 33 containing the organic compounds to be treated. Thus, a maximum amount of ozone can be dissolved into the water. Further, good mixing between the ozone and the organic compounds in the waste stream 33 can be achieved using the venturi.

The system illustrated in FIG. 3 can be used to circulate the ozonated waste stream 35 back to the storage facility 70 via conduit 18 where it can return to the storage facility 70 at exit 28. In general, waste exit 28 can be located below the waste surface 31 of storage facility 70, such that any unreacted ozone still remaining in the ozonated stream 35 at exit 28 can contact additional carbonaceous waste 30 held in the storage facility 70 as the ozone mixes with and passes through the waste 30. Thus, very little ozone can remain unreacted at the surface and, in the case of a storage facility open to the environment, very little ozone can be released from the storage facility 70.

In one embodiment, the system can include an ozone sensor 36 at or near the surface 31 of storage facility 70 with a feedback loop to the ozone system 60, such that if released ozone levels increase beyond a desired set point, the amount of ozone produced by the ozone system 60 can be decreased.

In one embodiment, the off-gases at the surface 31 of the waste held in storage facility 70 can be treated, such as with UV light, so as to destroy any remaining ozone in the off-gases prior to release into the environment.

The continuous recirculation of carbonaceous waste through the system of the present invention, as illustrated in FIG. 3, can enable not only essentially complete oxidation of the organic material in the waste, but also disinfection of the waste to whatever desired purification levels are desired. For example, in one embodiment, the waste can be recirculated through the ozonation loop to the point that complete oxidation of essentially all organic matter in the waste can be attained. In one embodiment, the treated waste can comply with regulatory discharge standards and thus be safely discharged into the environment or disposed of in a more permanent way, such as in a landfill, with no further treatment necessary.

In one embodiment, the waste treatment system of the invention can be on shipboard or in another isolated location such as in a hospital or research facility. In particular, an isolated location can include a waste-generating location that is physically isolated, such as on shipboard, or in an environmentally isolated location, as well as waste-generating locations that are isolated through necessity due to possible safety hazards, such as research facilities and medical facilities.

According to one embodiment, the isolated waste-generating location can include a waste storage facility such as, for instance, a bilge tank, a ballast tank, or a waste tank for containing waste generated at the location that can include galley waste, medical waste, and the like. In one embodiment, the waste can be treated according to the process to the point where the treated waste can be considered to be decontaminated. According to the present disclosure, decontaminated waste can be considered to be waste that can be safely disposed of in a standard waste facility such as a standard municipal waste facility. For instance, when considering a medical facility, decontaminated waste can be “green bag” waste rather than “red bag” waste. For example, decontaminated waste can be disposed of in a landfill, in a sewage treatment system, and the like. In one embodiment, the treated waste can comply with regulatory discharge standards and can be suitable for discharge into the environment or disposal in a landfill. The treated waste or water carrying the waste can have, for example, Biochemical Oxygen Demand (BOD) less than about 30 mg/L, Total Suspended Solids (TSS) less than about 30 mg/L, and/or Fecal Coliforms (FC) less than about 200 colonies per 100 mL.

In one embodiment, the system can provide treated waste and/or treated water that can be suitable for use. For example, in the embodiment illustrated in FIG. 1, the treated wastewater can be pulled off of storage facility 70 and recirculated through the system as flush water to flush tank 20 or otherwise used as gray water. In such embodiments, it may not be necessary to completely oxidize all carbonaceous components of the waste during the process. Beneficially, the parameters of the present system and methods can be adjusted depending on the desired oxidation level of any water used in the process as well as the solids contained in the waste. For instance, in one embodiment, all carbonaceous solids contained in the waste can be completely oxidized to form carbon dioxide, carbon monoxide, water, and oxygen.

In another embodiment, however, a portion or even all of the carbonaceous solids in the waste can remain intact following the disclosed process. For example, according to one embodiment, a majority of the dissolved or microscopic carbonaceous compounds in the waste can be oxidized during the process, while larger carbon-containing and/or inorganic solid materials can remain. As such, solid materials removed from the waste facility 70 following the treatment process can be at least decontaminated though not necessarily degraded by the process. Similarly, in one embodiment, larger carbonaceous solids can be partially degraded through the disclosed process. For example, in one embodiment, carbon-based polymeric materials (either synthetic materials, naturally occurring materials, or a combination of both) can be left essentially intact or partially degraded during the process. Partial degradation of solid materials contained in the waste during the disclosed process can increase the rate of the eventual complete degradation of the material. For example, following treatment of waste including biodegradable solid carbonaceous materials according to one embodiment of the disclosed process, remaining biodegradable carbonaceous solid materials removed from the storage facility can degrade in a permanent disposal site, e.g., a landfill, more quickly than identical biodegradable materials not subjected to the disclosed ozone treatment process.

Referring again to FIG. 3, an ozone sensor 36 at or near the surface of the storage facility can be utilized to determine the amount of ozone escaping from the system. This information can be further utilized to estimate the amount of carbonaceous waste remaining in the facility and/or the purity of water in the facility at any given time. For example, during the process, as the organic constituents in the wastewater are oxidized, more of the ozone released into the storage facility 70 from ozone system 60 can reach the surface of the facility and an increase in released ozone levels can become apparent. Thus, increasing levels of ozone released at the surface of the wastewater can indicate increased purity of the water. For instance, as ozone levels released at the surface of the wastewater approach the rate of ozone production, levels of organic matter in the wastewater can approach zero. Thus, an ozone sensor 36 at or near the surface 31 can be utilized to signal when the desired organic content of the waste has been attained. According to one embodiment, when purity levels reach the desired value, the processed materials can be released from storage facility 70 into the environment or optionally to a permanent disposal facility, e.g., a wastewater treatment facility via a sewer system or a landfill.

Water released from storage facility 70 can have various organic content levels, depending on the final destination of the treated water following release from storage facility 70. For example, whereas complete oxidation of all organic material in the waste is possible according to the processes of the present invention, in certain embodiments, this purity level may not be necessary, or even preferred. For example, in one embodiment, the organic materials in the waste can be only partially oxidized, leaving a high oxygen content sludge or slurry in the storage facility including partially degraded solids. In one particular embodiment, a high oxygen content sludge can be harvested periodically and used for a variety of other possible processes. For example, in one embodiment, a high oxygen content sludge can be injected into a landfill to promote decomposition.

In those embodiments wherein a very low organic content is sought in the product, the desired purity levels can be beyond those attainable in an operation involving continuous addition of waste to the storage facility. In this embodiment, it can be preferable to run the system as a batch operation, rather than a continuous operation. For instance, when the storage facility is approaching full, or alternatively when very clean product is desired, the waste flow into the storage facility can be shut down for a period of time while circulation and contact of the waste with the ozone continues. Once the desired purity standards have been attained, product can be removed from the storage facility. Following removal of the treated product, waste can again begin to flow into the storage facility.

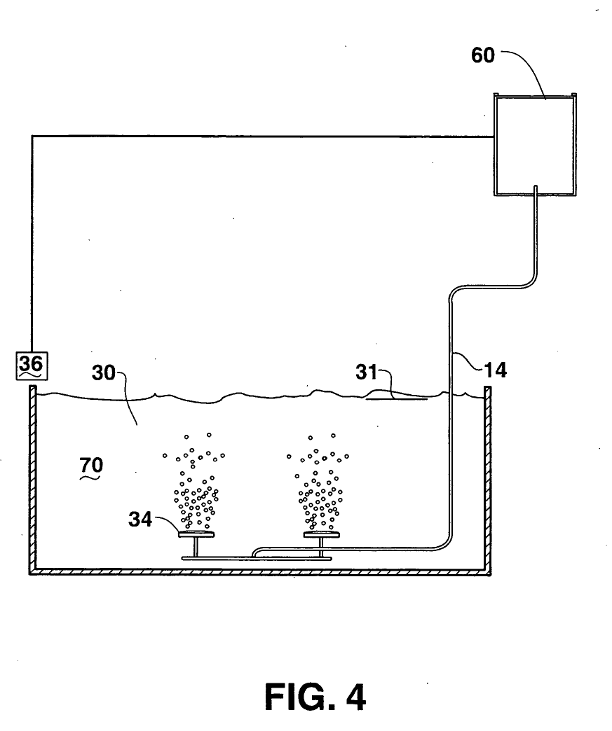

Another embodiment of the present invention is illustrated in FIG. 4. According to this embodiment, ozone can be delivered to storage facility 70 directly from ozone system 60 such as via submergible ozone diffuser 34. Submergible ozone diffuser 34 can include, for example, an ozone delivery device having an ozone resistant surface that can be placed at or near the bottom of waste storage facility 70. Possible ozone resistant materials for ozone diffuser 34 can include one or more of, for instance, silicone materials, polycarbonate materials, copper 316, stainless steel, CPVC, Teflon®, and the like. In addition, those surfaces of ozone diffuser 34 which can come in contact with waste 30 can be designed so as to be resistant to destructive contaminants that can be found in the waste 30.

The arrangement of ozone diffuser 34 can be such so as to encourage contact between the ozone and the organic materials in waste 30. For example, in one embodiment, ozone diffuser 34 can include lines, vessels, or the like which can include an array of holes of a size such that, at the desired ozone delivery rates, the ozone can bubble out of the diffuser 34 and up through the waste 30. For instance, a submergible ozone diffuser 34 can include ozone delivery holes of a diameter of between about 1 mm and about 5 mm. In one embodiment, the delivery holes can be about 2 mm in diameter. In various embodiments, ozone delivery holes can be clustered together in a series of discrete diffuser devices 34, as illustrated in FIG. 4, or alternatively can be more evenly spaced across the storage facility, for example spaced along one or more conduits laid across a span of the storage facility 70.

In one embodiment, the ozone released by ozone diffuser 34 can be in a high surface area form such as bubbles in order that a high percentage of the ozone can dissolve in the wastewater and oxidize organic elements in the waste prior to escape of unreacted ozone from the surface 31 of the storage facility 70. In one embodiment, in order to maximize contact time between the ozone and the waste, the ozone can be released from the submergible ozone diffuser 34 at a point well below the surface 31 of the waste 30. In one embodiment, the submergible ozone diffuser 34 can be placed at least about 9 feet below the surface 31 of the waste 30. While the submergible ozone diffuser 34 can be placed closer to the surface of the waste in other embodiments, such placement can utilize a lower ozone production and release rate or optionally post-release treatment of the atmosphere immediately above the surface 31 in order to prevent release of excessively high levels of ozone into the environment. This embodiment can also include an ozone sensor at or near the surface of storage facility 70 to monitor ozone production and release rates to help limit the amount of ozone released to the environment.

Release of ozone at or near the bottom of storage facility 70, whether direct from ozone generating device 60, as in the embodiment illustrated in FIG. 4, or mixed with the waste, as in the embodiment illustrated in FIG. 3, can not only clean and disinfect the waste, but additionally, a flow generated through the storage facility 70 can keep the waste agitated, preventing solids from settling on the bottom of the storage facility and facilitating contact and reaction between the ozone and the carbonaceous waste. In one embodiment, waste held in storage facility 70 can be agitated, such as by a stirring device or moving paddles or blades to facilitate contact between the waste and the ozone.

In yet another alternative embodiment, the present invention can be utilized for treatment of a waste storage facility containing high solids-content waste. For example, the present invention can be utilized for reclamation and remediation of a storage facility that has lost storage capacity due to accumulation of high solids-content carbonaceous waste in the facility. For purposes of this disclosure, high solids-content waste is herein defined to be waste that is at least about 50% solids. For example, in one embodiment of the invention, the waste can be dry, that is, 100% solids. In other embodiments, the waste can have some water content. For instance, the waste can be between about 50% and about 98% solids.

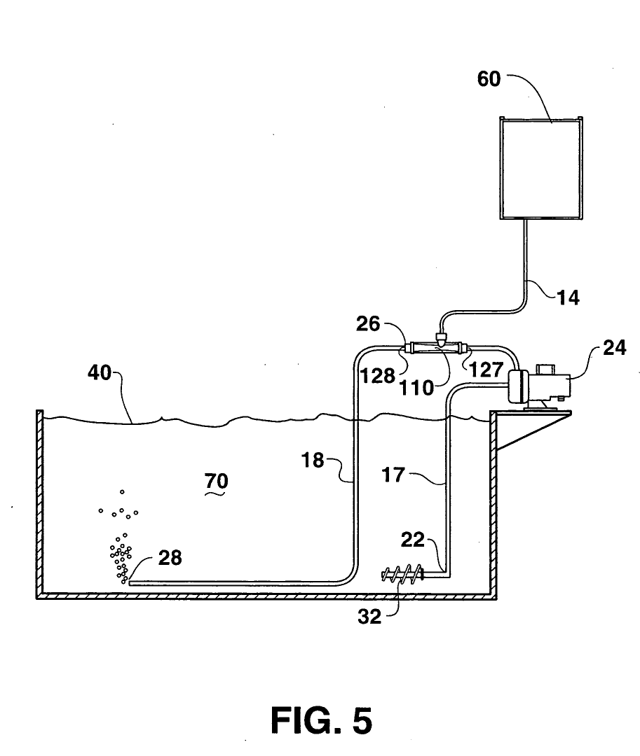

FIG. 5 illustrates one embodiment of the present invention including a storage facility 70 that is at least partially filled with high solids-content waste 40. As can be seen, the system includes waste intake 22 which can include a solids pick-up device such as an auger 32. The waste can then be pumped through conduit 17 to connector 26, where it can be contacted with ozone delivered via conduit 14 from ozone system 60. In this particular embodiment, connector 26 includes a venturi 110, but other connector designs are also contemplated according to the present invention. For example, the connector 26 can be any design that provides contact between the ozone and the waste stream such that oxidation of the organic material in the waste by the delivered ozone can begin.

In some embodiments of the invention, the high solids-content waste can be mixed with an amount of make up water prior to contact of the waste with the ozone. While not a requirement of the present invention, addition of water to a high solids-content waste stream can facilitate contact of the ozone with the carbonaceous waste and encourage oxidation of the waste.

As the ozonated waste circulates back into the storage facility 70 at waste exit 28, unreacted ozone can circulate through the storage facility 70 contacting the waste 40 and promoting further oxidation of the organic material in the waste.

In one embodiment, as the organic material in the high solids-content waste is broken down, and products including gaseous products such as CO₂, CO, and O₂ are released from the surface of the storage facility 70, the overall capacity of the storage facility 70 can increase, enabling the facility to accept additional waste material. For example, as the storage capacity of the facility increases, carbonaceous waste materials, either high solids-content waste material or lower solids-content waste materials, as desired, can be added to the storage facility.

In one embodiment, as the remediation of the storage facility continues, carbonaceous waste, and in one particular embodiment, carbonaceous waste having a solids-content somewhat lower than that of the waste filling the storage facility at the initiation of the treatment process, can be introduced to the storage facility. As the ozonation of the waste continues, and additional lower solids-content waste is added to the facility, the overall solids-content of the waste in the storage facility can begin to drop. Similarly, in those embodiments wherein an amount of make-up water is added to high solids-content waste to promote contact between the carbonaceous waste and the ozone, the overall solids-content of the waste held in the storage facility can begin to drop to lower levels as processing continues. Eventually, following an initial treatment period, it can be desirable to adjust the system characteristics to accommodate the now lower solids-content waste contained in the treatment facility. For example, at lower solids-content levels, the use of a solids pick-up device such as auger 32 or an associated grinder (not shown), may no longer be necessary. Similarly, the system can be adjusted as to pump characteristics, ozone flow rates, conduit diameters, etc. as the remediation process continues, so as to better accommodate the treatment requirements of the waste as the solids-content of the waste changes through the process.

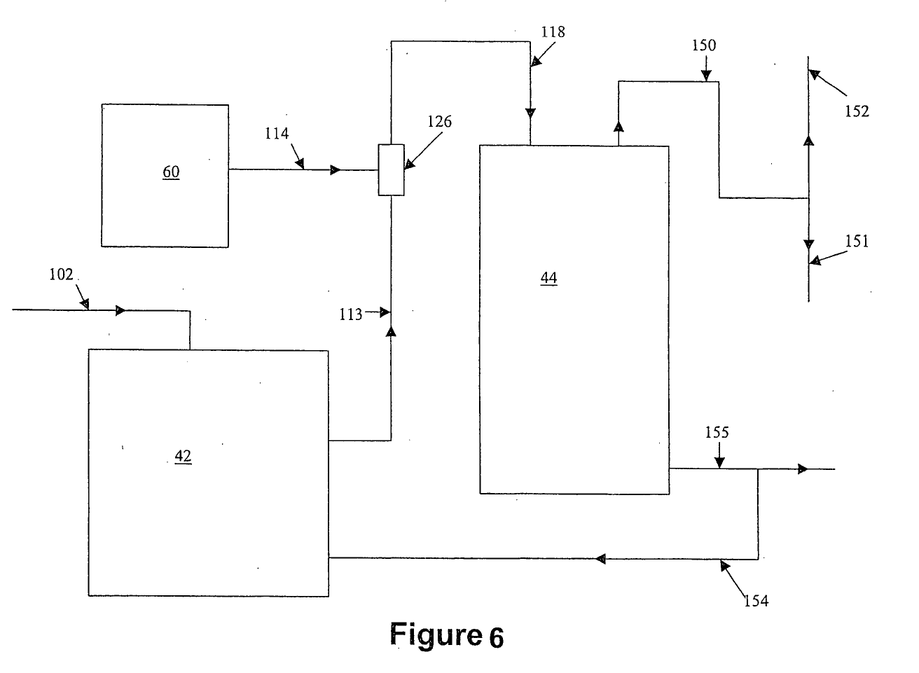

In another alternative embodiment, illustrated in FIG. 6, the present system and process can be suitable for treatment of carbonaceous waste which cannot be treated in a standard disposal process such as, for example, carbonaceous waste produced in remote locations or medical waste. For example, the present carbonaceous waste treatment process can be utilized by people such as armed forces personnel, researchers, explorers, villagers, or the like who can be in a location or producing waste which cannot be treated according to standard waste treatment facilities. In one embodiment, the present process can be utilized on shipboard, where waste storage facilities can be limited.

The present invention can have many applications to carbonaceous waste in remote locations. For example, the processes of the present invention can be used to treat black water or gray water, such as galley waste generated on shipboard. In one embodiment, the processes of the present invention can be used to treat water held in bilge tanks and/or ballast tanks on a ship. This can provide a method for safely releasing the water held in the bilge tanks and the ballast tanks without the environmental concerns previously carried with such release. For example, in one embodiment, the disclosed invention can be utilized to treat ballast water collected at one geographic location prior to release at another geographic location. This can help to prevent damage to ecosystems caused by the undesired yet often unavoidable transportation of living species such as plants, microbes, algae, and the like, from one geographic location to another in a ship's ballast water.

In another embodiment, the presently disclosed processes can be used to treat waste that can contain hazardous materials. For instance, the disclosed invention can be utilized to treat medical waste and thus render the medical waste safe for disposal according to typical waste disposal technologies. For example, following treatment of medical waste according to the disclosed invention, the waste can be rendered safe for disposal in a landfill.

Referring to FIG. 6, according to one embodiment, the waste treatment processing system of the present invention can include a waste storage chamber 42, where carbonaceous waste such as black water, gray water, medical waste, and the like, can be collected and stored until such time as enough waste has been collected to warrant operation of the system. For example, as waste is generated, it can be fed to storage chamber 42 via conduit 102. Conduit 102 can include filters, grinders, etc. as needed such that the waste collected in storage chamber 42 can be more efficiently processed according to the present invention. In one particular embodiment, the process can be automatic. For example, the storage chamber 42 can include level control capabilities. When an amount of carbonaceous waste has collected so as to exceed a preset level recognized by the control system, the system can be configured to automatically run a waste treatment process cycle. According to another embodiment, the system can be a manual operation including a manual feed of waste to storage chamber 42 and/or a manually operated switch to initiate a waste treatment process cycle.

In any event, at such time as enough carbonaceous waste has collected in storage chamber 42 so as to run a treatment cycle, waste held in chamber 42 can be pumped or otherwise conducted via line or conduit 113 to connector 126. This system can also include an ozone system 60. Ozone system 60 can deliver ozone or ozone enriched gas via line or conduit 114 to connector 126. At connector 126 ozone in line 114 can be combined with waste in line 113. In one embodiment, connector 126 can include a venturi (not shown) so as to promote contact between the ozone and the waste. Ozone enriched waste stream 118 can lead from connector 126 to a contact chamber 44. According to the present invention, contact chamber 44 can be configured as a tank, a drum, a chamber, a cylinder, a fluid hose, a fluid pipe, or any other shape that can allow contact between carbonaceous waste collected in the storage chamber 42 and ozone generated in ozone system 60.

In an alternative embodiment of the invention, ozone and waste can be fed to contact chamber 44 via separate lines, such that contact between the ozone and the carbonaceous waste can first take place within contact chamber 44.

Waste can be held in contact with ozone in contact chamber 44 for a suitable time to promote oxidation of the carbonaceous waste. In one embodiment, the ozone enriched waste held in the contact chamber 44 can be agitated, as with a stirring system, or by bubbling ozone enriched air through the waste, so as to promote contact between the waste and the ozone and encourage oxidation of the organic compounds in the waste.

As the oxidation reactions proceed in contact chamber 44, off-gases can be released from vessel 44 via line 150. Line 150 can further be split to lines 151 and 152. Line 151 can include a moisture trap, allowing collection of moisture from the off-gases, and line 152 can be released into the environment. In one embodiment, line 152 can include an ozone destruct module, such as a UV light, for example, in order to destroy any unreacted ozone in the off-gases prior to release of the off-gasses to the environment.

After the desired ozone/waste contact time, when the product has reached the desired purity level, the product can be removed from the contact chamber 44 via line 155. For example, product water can be removed from tank 155 and can be utilized as gray water, or optionally released into the environment, depending upon the purity level of the treated water. In one embodiment, at least a portion of the product water can be recycled to storage chamber 42 as make-up water for additional waste entering the system at line 102.

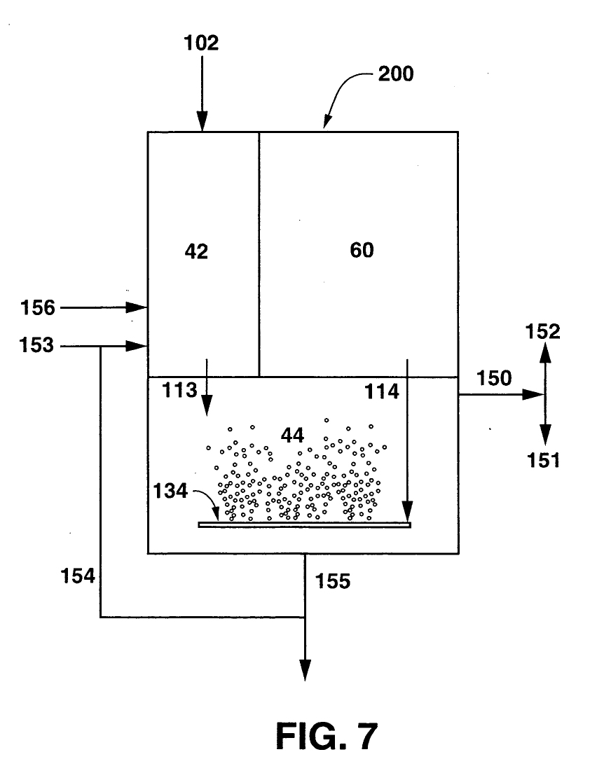

Another embodiment of the disclosed system is illustrated in FIG. 7. According to this embodiment, the entire system can be combined into a single self-contained unit 200. For instance, in one embodiment, unit 200 can be a portable unit sized to handle relatively small amounts of waste in a single batch treatment process. For example, unit 200 can take up less than about 40 cubic feet, in one embodiment. In another embodiment, unit 200 can take up less than about 30 cubic feet. In one embodiment, unit 200 can process between about 2 and about 20 kilograms of waste materials in a single batch treatment process. Beneficially, the self-contained unit of the present invention can be sized to treat any amount of waste, from single, small batches of only a few liters (for instance, about 3 liters), up to large batches of waste of several thousands of liters at a time.

According to one embodiment, a waste stream 102 can be fed either manually or automatically into storage chamber 42. In one embodiment, unit 200 can be designed for treatment of large solid materials, such as medical waste materials that can be collected during medical or laboratory research processes. For example, waste stream 102 can include solid medical waste including tubing, syringes, scalpels, sutures, gloves, gowns, masks, needles, gauze pads, draping material, and the like.

According to one embodiment, it may be desirable to include a grinding or chopping device in or near storage chamber 42, to grind or chop at least a portion of the solid waste materials into smaller pieces and thus increase the overall surface area of the solid materials so as to promote contact between the solid waste materials and ozone. Optionally, storage chamber 42 can also include a feed line 156 for feeding a refrigerant to storage chamber 42. For example, in one embodiment, liquid nitrogen can be fed in or around storage chamber 42 such as via line 156. Reducing the temperature of the solids held in the storage chamber 42, such as with the utilization of liquid nitrogen or some other refrigeration process can facilitate the grinding or chopping of the solid materials in the waste. Optionally, water can also be added to a high-solids content waste, such as at line 153, and can facilitate contact between the waste materials and the ozone.

According to the illustrated embodiment, waste can be fed from storage chamber 42 to contact chamber 44 such as via line or port 113. As previously mentioned in regard to other embodiments of the invention, a separate contact chamber 44 is not a requirement of the invention, and in another embodiment, the storage chamber 42 and the contact chamber 44 can be combined as a single contact chamber.

Unit 200 also includes an ozone system 60, similar to that described in other embodiments of the invention. For instance, ozone system 60 can include an ozone generating device and can deliver ozone, for example in the form of ozone-enriched air, to contact chamber 44 via line 114. Ozone can be delivered within contact chamber 44 so as to contact waste in vessel 44 according to any suitable design. For example, in the embodiment illustrated in FIG. 7, ozone can be fed to contact chamber 44 via line 114 where it can be dispersed throughout contact chamber 44 such as via dispersion device 134. In one embodiment, the waste can be in the form of an aqueous solution, sludge, or slurry, such that as the ozone bubbles through the waste, contact with organic materials and oxidation of the organic materials can occur. In other embodiments, the waste can be a high-solids content waste, and include little or no fluids. According to this embodiment, however, the ozone can be dispersed through the waste in a similar fashion. In one embodiment, the contact vessel can be sealed, so as to hold the ozone in contact with the waste materials for a suitable time for the desired amount of oxidation of the waste as well as to prevent the escape of untreated waste from the unit 200.

Following oxidation of the waste to the desired levels of degradation or purification, the products can be removed from the contact chamber 44. For example, the gaseous products, including any remaining ozone, can be removed via line 150, as described above for the embodiment illustrated in FIG. 6, and solid and/or liquid products can be removed via line 155. Optionally, water removed from contact vessel 40 can be recycled as shown via line 154.

Solid materials removed from the system can be disposed of or recycled. For example, in one embodiment, the disclosed system can be used to treat medical waste such as that generated at a medical or research facility. According to this embodiment, solid materials remaining following the ozone treatment process can be decontaminated and safe for standard waste disposal (e.g., landfill disposal). For example, medical waste such as sharps (e.g., scalpels, scissors, needles, etc.), trays, syringes, plastic materials, and the like can be treated according to the disclosed process, sterilized, and utilized again in the medical/research facility or optionally can be decontaminated according to the process and rendered safe for ‘green bag’ disposal in a standard waste disposal system, such as a municipal waste disposal system, for example.

In one embodiment, the self-contained unit can be portable. For example, the unit can be unattached or removably attached to a surface for easy relocation. In one embodiment, the unit can be on wheels for easy relocation.

In addition to the processes described above, there are a variety of optional pre- and post-treatments that can be utilized in conjunction with the present invention. For example, the waste can be pre-treated using oil separators, solid separators, de-watering systems, settling basins, etc. prior to introduction of ozone to the waste.

In one embodiment, a small amount of ozone can be introduced to the waste prior to deposition of the waste in the storage facility. For example, referring again to FIG. 1, a small amount of ozone can be introduced to the waste as it travels along conduit 11 by use of a venturi, a nozzle, a T-connection, or the like. Introduction of a small amount of ozone to the waste as a pre-treatment can begin the oxidation of the waste prior to deposition in the storage facility. In addition, a small amount of ozone injected into the waste stream can precipitate solids in the waste. The partial oxidation of organic material from a small amount of introduced ozone can lead to the agglomeration of small particulate material in the waste stream. The agglomerated material can then, and depending on the characteristics of the material, fall out of suspension from the waste material, float to the top of the storage vessel, or remain suspended in the storage vessel. In any case, the agglomerated material can, in one embodiment, be removed from the other waste materials such as by mechanical means. Thus, the addition of a small amount of ozone in the stream prior to deposition of the waste in a storage facility can lead to reduction in the amount of organic material to be treated according to the disclosed process at a later time. In one embodiment, between about 0.2 mg/L and about 1.8 mg/L ozone could be introduced to the waste prior to the deposition of the water to a storage facility.

If desired, chemical flocculants as generally known could be added to the storage facilities. For example, flocculants such as alum, aluminum sulfate, ferric sulfate, ferric chloride, epi-amines, and the like could be added. Chemical flocculants can be utilized to help separate components from the waste. For instance, organic or inorganic components can be agglomerated and collected on the surface of the waste storage facility and periodically skimmed off of the top, filtered from, or removed from the bottom of the facility, depending upon the characteristics of the flocculated materials.

Optionally, additional oxidants or disinfectants could be utilized in conjunction with the ozone treatment. For example, hydrogen peroxide, ultraviolet light, chlorine, iodine, certain bacteria and even oxygen can be utilized in conjunction with ozone in sanitizing the carbonaceous waste. In one embodiment, the waste can first be collected in a storage tank where it can be subject to a dose of hydrogen peroxide and/or exposed to UV light. In this embodiment, the pretreated waste can then be pumped to the storage facility, where ozone treatment can take place. Optionally, as the waste is being pumped to the storage facility, a small amount of ozone can be introduced to the waste, as described above. Upon introduction to the storage facility, the waste can be treated according to the ozone treatment processes herein described. If desired, the entire system can be monitored using sensor technology that could increase or decrease the amount of ozone being delivered to the waste. Optionally, the system can also include devices, such as UV lights, for example, which can destroy any ozone remaining following contact of the ozone with the waste.

In one embodiment, in addition to the ozonation processes described above, the waste can be treated with advanced oxidation processes. Advanced oxidation generally refers to a reaction whereby substances containing highly reactive hydroxyl free radicals are utilized to oxidize a compound. In one embodiment, oxidation via hydroxyl radicals combined with the disclosed process can provide increased efficiency to the process as compared to oxidation via ozone alone.

In one embodiment of the present invention, decomposition of the added ozone can be accelerated in the waste in order to increase the concentration of hydroxyl radicals. Thus, in this particular embodiment, the organic material in the waste can not only be directly oxidized via reaction with ozone, but can also be oxidized via reaction with the hydroxyl radicals generated by the artificially accelerated ozone decomposition.

Several methods can be used to accelerate ozone decomposition in the waste and produce a higher concentration of hydroxyl radicals. For example, in one embodiment, hydrogen peroxide can be added to the ozonated wastewater, a process commonly termed a peroxone process. In this embodiment, hydrogen peroxide and ozone can combine to form highly energetic hydroxyl radicals that can help in the decomposition chemistries in the waste.

A process utilizing only ozone to decontaminate aqueous waste can rely heavily on the direct oxidation of the organic components of the waste with aqueous ozone. Peroxone processes, on the other hand, can rely primarily on oxidation of the waste with hydroxyl radicals. In the peroxone process, the ozone residual can be short lived, as the added peroxide can accelerate the ozone decomposition. However, the increased oxidation achieved by the hydroxyl radical can, in certain embodiments, outweigh the reduction in direct ozone oxidation because the hydroxyl radical can be much more reactive. The net result can be, in some embodiments, that the overall oxidation process can be faster utilizing a peroxone process as compared to a pure ozone molecular process.

In another embodiment of the present invention, the waste can be subjected to ultraviolet light. This can be carried out either before, during or after the oxidation process of the waste as previously described. UV light can be both germicidal and disinfect the waste stream as well as present the possibility of producing additional ozone for additional oxidation of the waste from oxygen carried in the waste.

If desired, water included in the waste can be further treated or utilized following the disclosed oxidation processes. According to this embodiment, any remaining solids can generally be separated from the water with a solids separation process, as is generally known in the art, prior to water treatment or utilization. For instance, the product water can be filtered or fine filtered, such as with a reverse osmosis or other ultra-filtration process. Following such further treatment, the filtrate can, in one embodiment, be potable, while the separated materials can include concentrated waste materials, which can be disposed of, further treated, or utilized for other applications, such as fertilizer applications.

Water treated according to the processes of the present invention can be removed from the storage facility following treatment and used for other purposes. For example the water can be used as irrigation water, recycled as charge water to a flush tank or storage facility of the system, or, depending on final purity levels attained, even utilized for animal or human consumption.

In one embodiment, the treated water removed from the storage facility can be supplied to growing plants. The water can facilitate plant growth by providing essential nutrients remaining in the treated product water to a growth media (soil) for the plant roots to absorb. For instance, seeds of plant species can be sown in or on a rooting media and the water can be supplied through a delivery device or by gravity flow, as shown in FIG. 1, in which the water can be removed from the storage facility following treatment and can be fed to a plant system 85.

In one embodiment, the water can be tested to determine approximate concentrations of essential minerals so that appropriate volumes of the water can be supplied to the plants.

In one embodiment, when utilizing the treated water, it can be desirable to aerate the water. Aeration of the water, if needed, can be accomplished by any standard method including, but not limited to, pumping or bubbling ambient air into the water or spraying the water to aerate it prior to its application as irrigation water.

Beneficially, as long as treated water removed from the storage facility complies with regulatory discharge standards, runoff and leachate from such a plant system need not be collected or tested prior to discharge into the environment.

The present invention may be better understood with reference to the Examples given below:

### EXAMPLE 1

Aqueous waste was collected from a swine waste lagoon located in rural Georgia. Eight liters of the aqueous waste was placed in a test column where it was contacted with ozone generated from an ozone generating system with a capacity of 6.6 grams/hour.

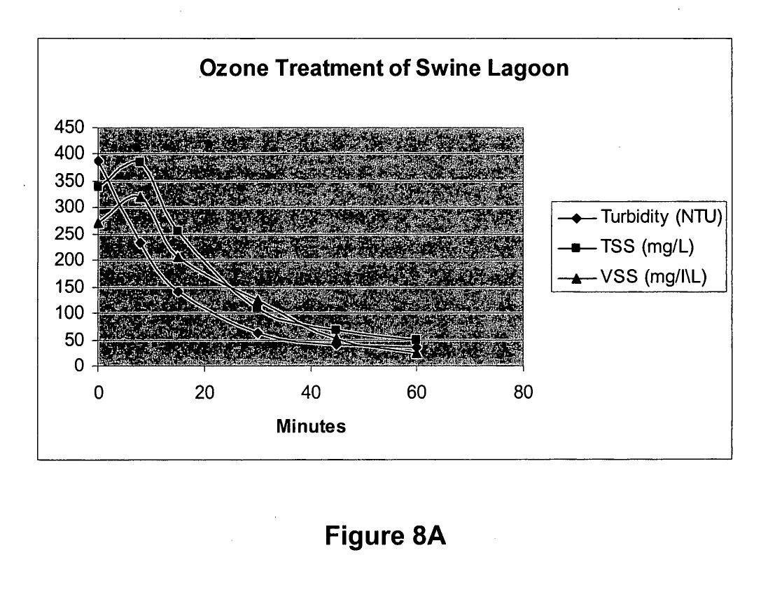

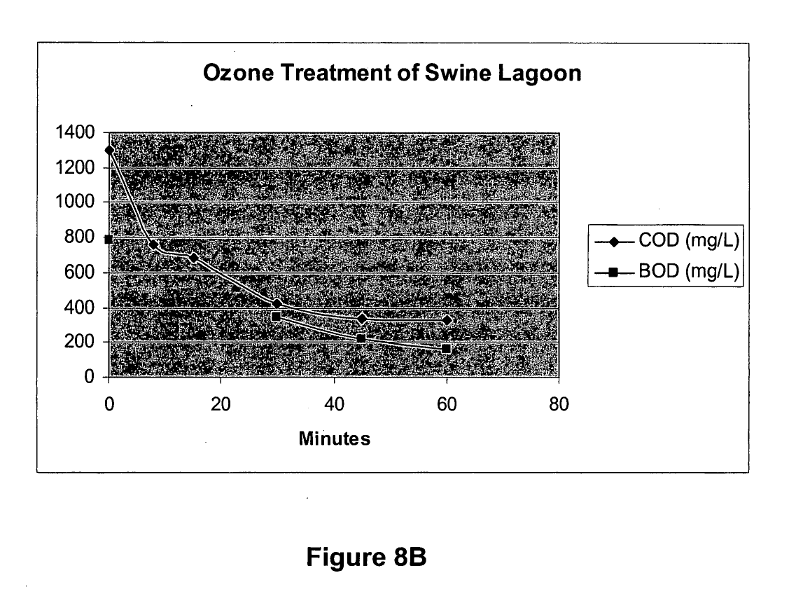

FIGS. 8A and 8B graphically illustrate the results of ozone contact on the aqueous waste in regard to Turbidity, measured in NTU (Nephelometric Turbidity Units), total suspended solids (TSS), volatile suspended solids (VSS), COD and BOD.

### EXAMPLE 2

A seven million gallon swine waste lagoon located in Missouri that receives waste from two swine barns, each housing 2,000 pigs, was treated according to the presently disclosed process. The swine waste was flushed every two hours with 2,200 gallons of water. The waste flush was carried out over five days during which the flushed waste was stored. At the end of this period, the waste was transferred to the lagoon. Ozone was added to the lagoon by means of two spargers placed on the bottom of the lagoon and connected to an ozone system at the edge of the lagoon. The ozone generator had an output of approximately 18 pounds of ozone per day.

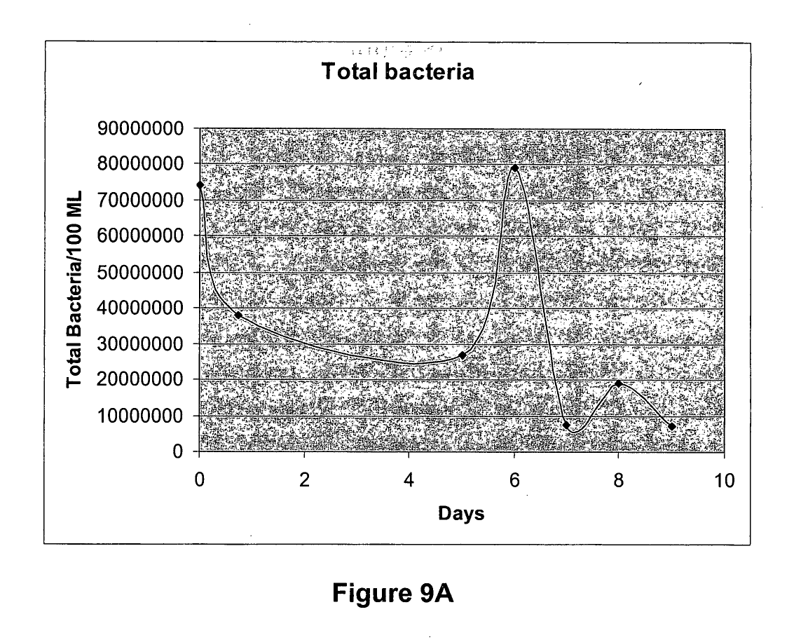

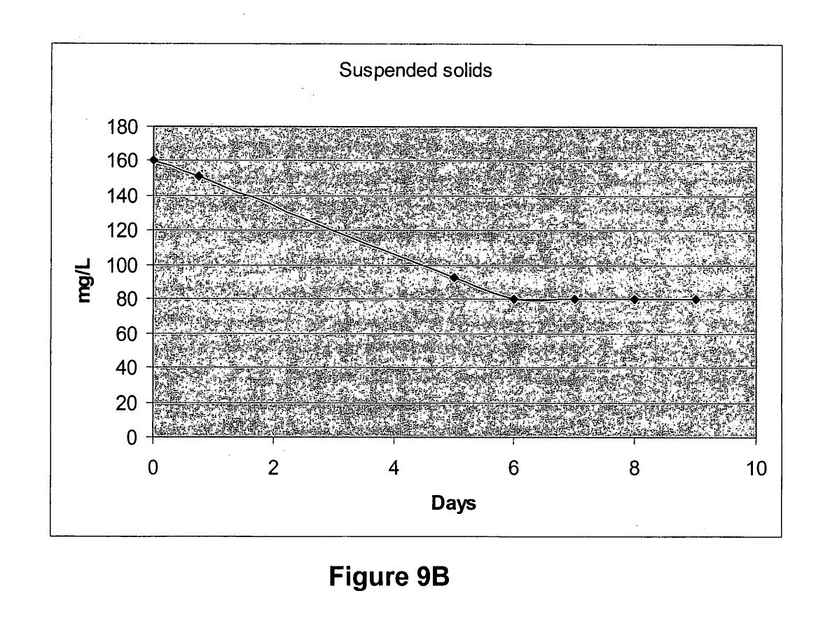

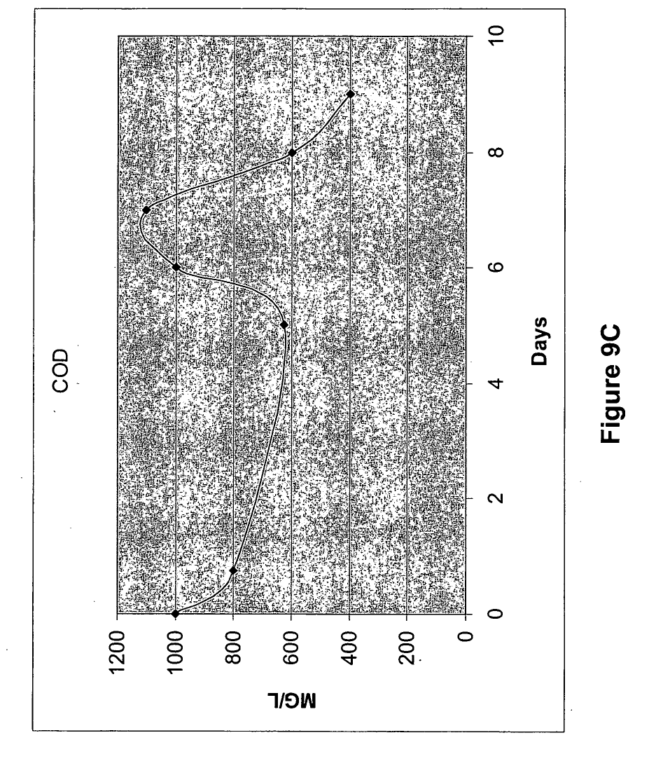

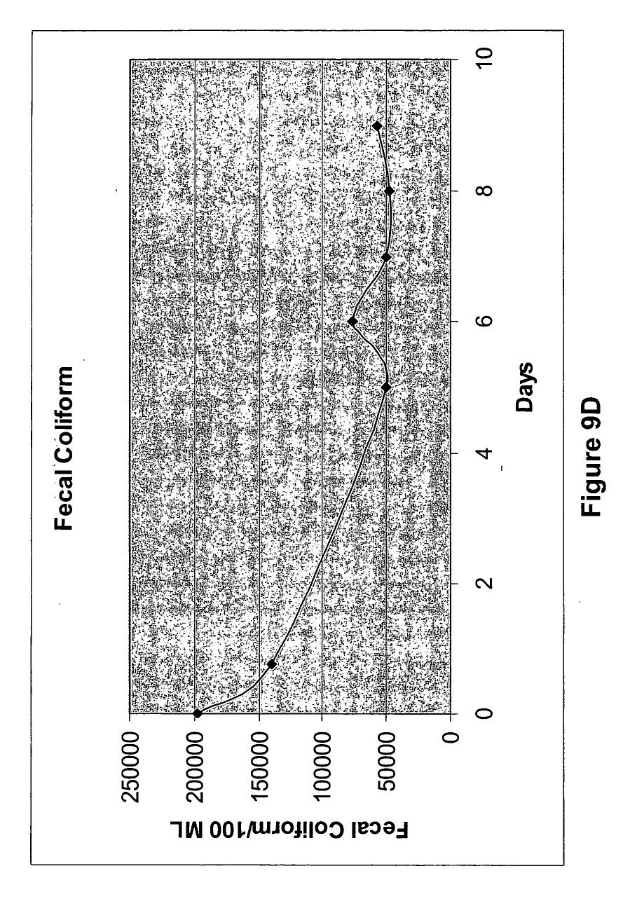

Samples were taken from the lagoon over the entire duration of the test and examined for fecal coliform, total bacteria, total suspended solids, and chemical oxygen demand (COD). Results can be seen in FIGS. 9A-9D. The addition of the swine waste to the lagoon at Day 5 can be seen in the Figures.

### EXAMPLE 3

Waste was collected from the floor of a dairy operation in Oregon with the use of very little water. The waste was approximately 30-50 times as concentrated as flushed waste such as that treated in Examples 1 and 2, above.

Samples of 8 liters wet volume were treated for a period of 180 minutes with ozone supplied to the sample at a rate of 6.6 g/hr. Results are illustrated below in Table 1.

TABLE 1

| | Initial Value | Final Value |
|---|---|---|
| BOD (mg/L) | 4,450 | 2,880 |
| COD(mg/L) | 18,200 | 9,200 |
| Fecal Coliforms/100 mL | 1,600,000,000 | <2,000 |
| Phosphorous (mg/L) | 110 | 90 |
| Suspended Solids | 11,800 | 4,070 |
| (mg/L) | | |
| Volatile Solids (mg/L) | 7,670 | 5,670 |

### EXAMPLE 4

A series of tests were run on freshwater samples obtained from ponds and rivers. These samples had various concentrations of TSS, turbidity and chemical oxygen demand (COD). The water samples were collected from a waterfowl area in Northeast Madison County, Ala. The grab samples were collected near bridge access sites and kept cool until analysis the same day.

The first series of test were performed on pond water that had a high TSS, turbidity and appeared to contain a lot of algae as suspended particles. Table 2, below shows the results of the initial settling tests of the sample taken from the waterfowl area including suspended solids (mg/L) and turbidity.

Four 1-liter volumes of the samples were ozonated at dosages of 42, 125, 250 and 500 ppm to determine the effects of ozonation on TSS, turbidity and COD. The test procedure consisted of placing 2-L of the water sample inside a sealed Pyrex reactor with the ozonator's diffuser placed in direct contact with the sample and allowed to run until the desired dosage was applied. A magnetic stir bar was placed inside of the reactor to ensure complete mixing of ozone and sample. These samples were then poured into Imhoff cones and allowed to settle for 1 hour as per SM #2540 F. Results are illustrated in Table 2 and indicate that the ozonated samples exhibited an increased removal of TSS and turbidity of over 50% over the non-ozonated sample.

TABLE 2

| Ozone | Settleable | | | | |
|---|---|---|---|---|---|
| Dosage, | Solids, | Turbidity, | TSS, | | |
| (ppm) | mL/L | (NTU) | (mg/L) | Δ Turbidity | Δ TSS |
| 0 | <0.1 | 32 | 61 | | |
| 42 | <0.1 | 30 | 61 | 6 | 0.5 |
| 125 | <0.1 | 28 | 56 | 13 | 9 |
| 250 | 0.1 | 24 | 55 | 25 | 9 |
| 500 | <0.1 | 16 | 36 | 50 | 41 |

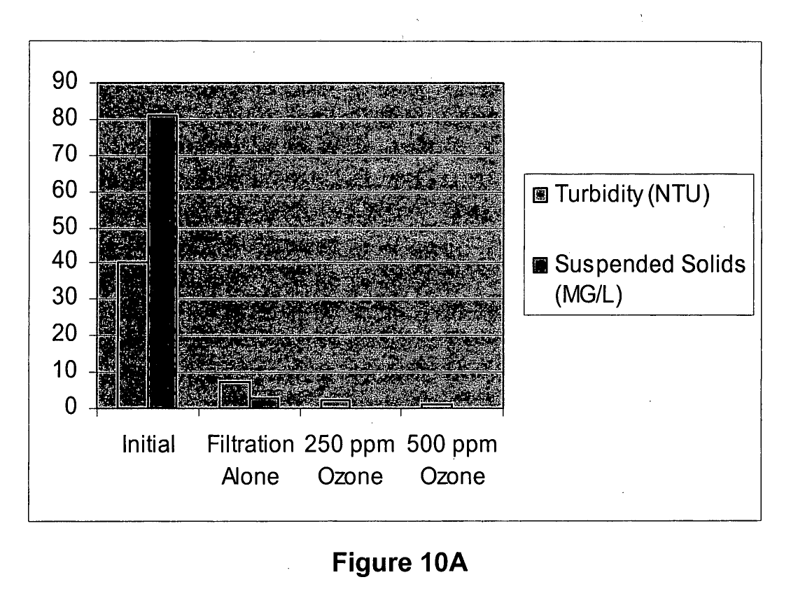

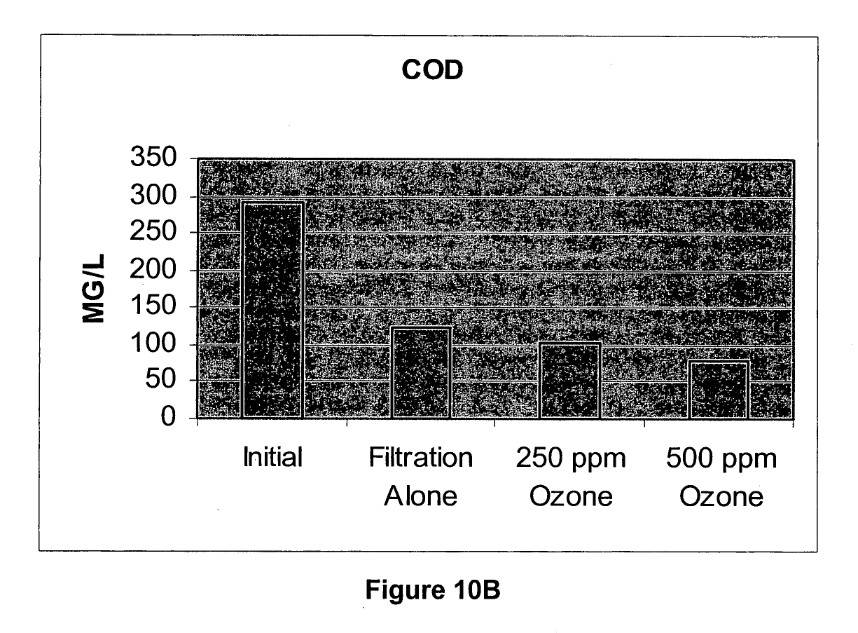

The freshwater samples from the waterfowl area were also treated with ozone in combination with a pre-filtration process. Samples were treated with filtration alone, or treated according to the present invention with ozone at an amount of either 250 ppm or 500 ppm and then filtered using a standard water filter designed for in-home tap water filtration use. Results are illustrated in FIGS. 10A and 10B. As can be seen, the pre-ozonation of the water sample improved the filtration process.

### EXAMPLE 5

A surface water sample was collected from the Tennessee River near Decatur, Ala. for a series of coagulation (FeCl₂) tests. Four different FeCl₂ doses were used along with a combination of three different Ozone doses (0, 1 ppm and 2 ppm). These tests were performed similarly to standard methods for bench scale jar testing of coagulants. Specifically, the coagulant (FeCl₂ obtained from Sigma Chemical Co, Milwaukee, Wis.) was mixed into deionized water for a standard solution, which was used in all subsequent testing. That standard coagulant solution was added to the surface water samples with a rapid mixing phase in a batch process and slowly mixed for a minimum of 10 minutes to assure complete mixing and flocculation formation. The water was then filtered with a 200 micrometer screen as pretreatment and then treated with a microfilter similar to the previous example. Testing was performed to determine if there was any improvement to COD, TSS or turbidity treatment prior to a process.

The coagulant bench scale tests were performed on Tennessee River water with the various combinations of three different FeCl₂ and two ozone dosages, also a no ozone-no coagulant test was also performed for a baseline comparison. The initial concentration of Suspended Solids was 4.65 mg/L. Table 3 illustrates the suspended solids in ppm obtained with various levels of ozone dosage and coagulant amounts. As can be seen with reference to Table 3, the highest dose of pre-ozonation (2 ppm) did improve the suspended solids removal efficiency at the two higher FeCl₂ dosages. However there was little improvement at the lower dose of FeCl₂.

TABLE 3

| FeCl₂ Dosage | Ozone Dose (ppm) | | |
|---|---|---|---|
| (ppm) | 0 | 1 | 2 |
| 0 | 0.85 | 0.45 | 0.85 |
| 0.125 | 0.6 | 0.35 | 0.5 |
| 0.25 | 0.45 | 1.2 | 0.15 |
| 0.75 | 0.75 | 0.75 | 0.1 |

Tests for Chemical Oxygen Demand were also performed. The initial COD was 6.0 mg/L before screening and filtration were performed. Table 4 tabulates the values in ppm obtained for COD at various ozone dosage levels and coagulant amounts. As can be seen with reference to Table 4, the zero dose of coagulant produced much higher COD values than the tests with FeCl₂.

TABLE 4

| FeCl₂ Dosage | Ozone Dose (ppm) | | |
|---|---|---|---|
| (ppm) | 0 | 1 | 2 |
| 0 | 5 | 4 | 6 |
| 0.125 | 3 | 5 | 3 |
| 0.25 | 2 | 2 | 4 |
| 0.75 | 4 | 4 | 3 |

### EXAMPLE 6

An aqueous sample (approximately 1 gallon, 3.8 liters) contaminated with blood and swine waste was contacted with ozone as herein described. Following 30 minutes of treatment at a dosage level of 1.2 g/hr, reductions in waste parameters were obtained as follows:

| | |
|---|---|
| COD | 20% reduction |
| Fecal Coliform | 21% reduction |
| Total Bacteria | 22% reduction |
| Turbidity | 56% reduction |

It will be appreciated that the foregoing examples, given for purposes of illustration, are not to be construed as limiting the scope of this invention. Although only a few exemplary embodiments of this invention have been described in detail above, those skilled in the art will readily appreciate that many modifications are possible in the exemplary embodiments without materially departing from the novel teachings and advantages of this invention. Accordingly, all such modifications are intended to be included within the scope of this invention that is defined in the following claims and all equivalents thereto. Further, it is recognized that many embodiments can be conceived that do not achieve all of the advantages of some embodiments, yet the absence of a particular advantage shall not be construed to necessarily mean that such an embodiment is outside the scope of the present invention.

1. A process for treating waste comprising:
collecting medical waste in a treatment chamber; and
contacting the medical waste in the treatment chamber with a gas comprising ozone, wherein the ozone is present in the chamber in an amount sufficient to oxidize at least a portion of any organic matter contained in the medical waste and decontaminate the medical waste.

2. The method according to claim 1, wherein the medical waste is an aqueous waste.

3. The method according to claim 2, wherein the decontaminated medical waste has a total suspended solid of less than about 30 mg/L.

4. The method of claim 2, further comprising introducing chemical flocculants to the aqueous waste.

5. The method of claim 2, further comprising adding hydrogen peroxide to the aqueous medical waste prior to contacting the waste with the gas comprising ozone.

6. The method according to claim 1, wherein the decontaminated medical waste has a biochemical oxygen demand of less than about 30 mg/L.

7. The method according to claim 1, wherein the medical waste comprises blood.

8. The method according to claim 1, wherein the decontaminated medical waste has a fecal coliform count of less than about 200 colonies/100 mL.

9. The method according to claim 1, wherein the medical waste comprises solid materials.

10. The method according to claim 9, wherein the solid materials comprise carbonaceous solid materials.

11. The method according to claim 10, wherein the medical waste comprises solid carbonaceous polymeric materials.

12. The method according to claim 11, wherein the carbonaceous polymeric materials comprise biodegradable polymeric materials.

13. The method according to claim 10, wherein the method comprises at least partial degradation of the carbonaceous solids.

14. The method according to claim 9, the method further comprising grinding or chopping at least a portion of the solid materials.

15. The method according to claim 14, the method further comprising cooling the solid materials prior to grinding or chopping the materials.

16. The method according to claim 1, the method further comprising the disposal of the decontaminated waste.

17. The method according to claim 16, wherein the disposal of the decontaminated waste comprises disposal of the decontaminated waste in a municipal waste disposal facility.

18. The method of claim 1, wherein the medical waste is an aqueous slurry.

19. The method of claim 1, further comprising separating any solids from the decontaminated waste.

20. The method of claim 1, further comprising contacting the gas with ultraviolet light subsequent to the contact of the medical waste with the gas.

21. The method of claim 1, further comprising filtering the medical waste prior to contacting the waste with the gas comprising ozone.

22. A waste treatment unit comprising:
a contact chamber;
a waste inlet for depositing waste into the contact chamber;
an ozone system for providing a gas comprising ozone to the contact chamber such that the ozone can contact waste deposited into the contact chamber in an amount sufficient to oxidize at least a portion of any organic matter contained in the waste;
an outlet for removing treated waste from the waste treatment unit; and
wherein the waste treatment unit is a self-contained waste treatment unit.

23. The waste treatment unit of claim 22, further comprising a device for chopping or grinding solid waste materials.

24. The waste treatment unit of claim 22, further comprising a waste storage chamber for storing waste prior to depositing the waste in the contact chamber.

25. The waste treatment unit of claim 22, wherein the ozone system comprises an ozone-generating device.

26. The waste treatment unit of claim 22, the unit further comprising a solids separating device for separating solids from the treated waste.

27. The waste treatment unit of claim 22, the unit further comprising an ultraviolet light.

28. The waste treatment unit of claim 22, wherein the self-contained waste treatment unit occupies less than about 40 cubic feet of space.

29. The waste treatment unit of claim 22, wherein the self-contained waste treatment unit occupies less than about 30 cubic feet of space.

30. The waste treatment unit of claim 22, wherein the waste treatment unit is for decontaminating medical waste.

31. The waste treatment of claim 22, wherein the waste treatment unit is portable.
